(19) United States
(12) Patent Application Publication
(10) Pub. No.: US 2003/0086356 A1
(43) Pub. Date: May 8, 2003

(54) Optical pickup and optical disk device

(76) Inventors: Mineharu Uchiyama, Kawasaki-shi (JP); Yoshiharu Imaoka, Sagamihara-shi (JP)

Correspondence Address: PILLSBURY WINTHROP, LLP, P.O. BOX 10500, MCLEAN, VA, 22102, US

(21) Appl. No.: 10/266,567

(22) Filed: Oct. 9, 2002

(30) Foreign Application Priority Data
Nov. 8, 2001 (JP) 2001-342817

(51) Int. Cl. G11B 7/00

(52) U.S. Cl. 369/121

(57) ABSTRACT

In an optical pickup according to the present invention, a driving device, which independently supplies predetermined driving signals to a first light source and a second light source, is disposed in a notch specified by two planes, so as to suppress the deterioration of the driving signals. The two planes are defined by a vertical line, which is vertical to an intersection where an optical axis of the first light source and an optical axis of the second light source intersect, and the two axes.

### CROSS-REFERENCE TO RELATED APPLICATIONS

This application is based upon and claims the benefit of priority from the prior Japanese Patent Application No. 2001-342817, filed Nov. 8, 2001, the entire contents of which are incorporated herein by reference.

### BACKGROUND OF THE INVENTION

1. Field of the Invention

The present invention relates to an optical disk device that irradiates a light beam to a signal recording surface of an optical disk so as to record an information signal and reproduce the information signal from the optical disk. The invention also relates to an optical pickup that can be used for the optical disk device.

2. Description of the Related Art

Jpn. Pat. Appln. KOKOKU Publication No. 59-9086 (Date of publication: Feb. 29, 1984) is a document in which the well-known art in the technical field to which the present invention pertains.

In Jpn. Pat. Appln. KOKOKU Publication No. 59-9086, disclosed is that a laser element to irradiate a light beam on a signal recording surface of an optical disk is driven by two sources; a direct current source and a high frequency current source, so as to oscillate the laser element in a multiple vertical mode, thereby obtaining a light beam, and the obtained light beam is irradiated on the signal recording surface of the optical disk so that a low frequency band noise of an optical beam output is suppressed.

A high frequency superposition technology according to the present invention, which will be described later, has the capability of reducing noise included in a reproduction light that is reflected by a recording surface of an optical disk. The technology is applied to an optical pickup in an optical disk device, which is capable of recording and/or reproducing signals on and/or from a DVD-RAM disk, and a CD-R and/or CD-RW disk. The DVD-RAM disk is a recording disk of the DVD (Digital Versatile Disc) system, which is recently becoming main stream. The CD-R and/or CD-RW disk is a recording disk of the CD (Compact Disk) system.

The optical pickup according to the invention includes laser elements, which are capable of recording information on the disk for the DVD system and the disk for the CD system, and capable of reproducing information from the disks of the respective systems.

The problem, here, is the distance or the lengths of signal lines between each of the laser elements and a driving current supply unit, which provides a driving current, to the laser elements capable of supplying an optimal light beam to disks of the respective system, namely, a laser driver and each of the laser elements.

The larger the distance or the lengths of the signal lines between the laser driver and each of the laser elements is, the more the driving current supplied to each laser element receives influence on its transmission path from specific resistance. Therefore, a phenomenon occurs in that a signal waveform of a laser driving signal attenuates and deteriorates.

That is, the larger length of the signal line between the laser driver and the laser element becomes, the more serious the problem that the waveform of the driving signal deteriorates, and thus an appropriate high frequency driving signal (laser driving signal) cannot be obtained.

As described above, according to the technology, a problem lies in that, as the length of the signal line between the laser driver, which supplies the laser driving signal to the laser element, and the laser element increases, the signal waveform of the high frequency driving signal that is supplied to the driving signal for the laser element deteriorates.

The problem described above includes a further problem. That is, in the case where two or more laser elements are driven independently, if the respective lengths of the signal lines between two laser elements and the laser driver are different from each other, and it becomes difficult for the side in that the lengths of the signal lines between the laser driver and each of the laser elements is relatively larger to record information faithful to the driving signal supplied to the laser element at the time of recording information. In addition, at the time of reproducing information, a problem occurs in that signal characteristics of reproduction signals deteriorate.

### BRIEF SUMMARY OF THE INVENTION

An object of the invention provides an optical pickup in which a driving signal to be supplied to a light source less deteriorates, and an optical disk device using this optical pickup.

According to an aspect of the invention, there is provided an optical pickup comprising:

a first light source to emit a light beam having a first wavelength;

a second light source to emit a light beam having a second wavelength; and

a light source driving unit to position in a space which is surrounded by a first plane defined by a vertical axis and a first optical axis and a second plane defined by the vertical axis and a second optical axis, the first optical axis defining a direction in which a light beam from the first light source proceeds, the second optical axis defining a direction in which a light beam from the second light source proceeds, the vertical axis being vertical to an intersection where the first optical axis and the second optical axis intersect each other.

According to another aspect of the invention, there is provided an optical disk device comprising:

a first light source to emit a light beam having a first wavelength;

a second light source to emit a light beam having a second wavelength;

a light source driving unit to position in a space which is surrounded by a first plane defined by a vertical axis and a first optical axis and a second plane defined by the vertical axis and a second optical axis, the first optical axis defining a direction in which a light beam from the first light source proceeds, the second optical axis defining a direction in which a light beam from the second light source proceeds, the vertical axis being vertical to an intersection where the first optical axis and the second optical axis intersect each other;

a turntable on which an optical disk is mounted; and

a guide member to guide the optical pickup in a radius direction of the optical disk mounted on the turntable.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram for explaining an example of an optical pickup according to an embodiment of the invention;

FIG. 2 is a schematic diagram for explaining a possible space where a driving unit, which supplies a predetermined driving current to a laser element, is disposed in the optical pickup shown in FIG. 1;

FIGS. 3A and 3B are exploded views showing the optical pickup take apart shown in FIG. 1 (state viewed from the back thereof in FIG. 1);

FIGS. 4A and 4B are exploded views showing the optical pickup shown in FIGS. 3A and 3B viewed from the back thereof (the identical direction to FIG. 1);

FIG. 5 is a schematic diagram showing an example of the optical disk device in which the optical pickup explained with reference to FIGS. 1, 2, 3A, 3B, 4A and 4B is built;

FIG. 6 is a schematic diagram for explaining an example of another embodiment of the optical pickup explained in FIGS. 1, 2, 3A, 3B, 4A and 4B; and

FIG. 7 is a schematic diagram for explaining a possible space where a driving unit, which supplies a predetermined driving current to a laser element, is disposed in the optical pickup shown in FIG. 6.

### DETAILED DESCRIPTION OF THE INVENTION

Hereinafter, an embodiment of the invention will be described with reference to the accompanying drawings.

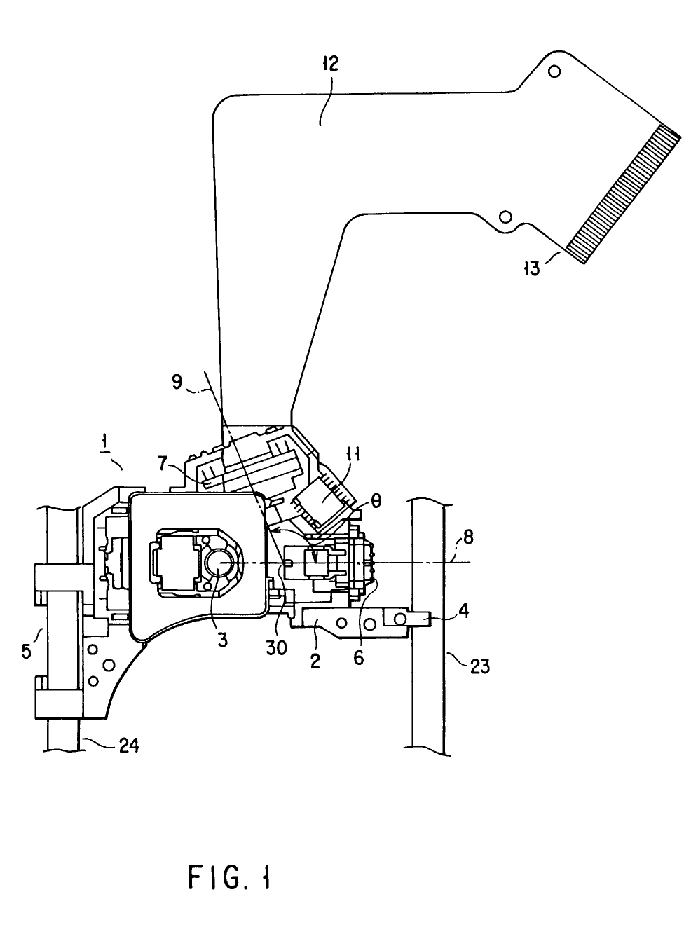

FIG. 1 is a schematic diagram for explaining an example of an optical pickup to which the embodiment of the invention is applicable.

As shown FIG. 1, an optical pickup 1 includes a base 2. On the base 2, there is provided an objective lens 3, a guide rod holding unit 4, a guide rod end sliding portion 5, an optical integration unit for a CD, namely CD optical integration unit 6, and an optical integration unit for a DVD, namely DVD optical integration unit 7.

In the CD optical integration unit 6 and the DVD optical integration unit 7, light sources (laser elements), each of which emits a light beam having the wavelength different from each other, are built.

The wavelength of the light beam emitted from the laser element built in the CD optical integration unit 6 is 780 nm, and the wavelength emitted through the laser element built in the DVD optical integration unit 7 is 650 nm.

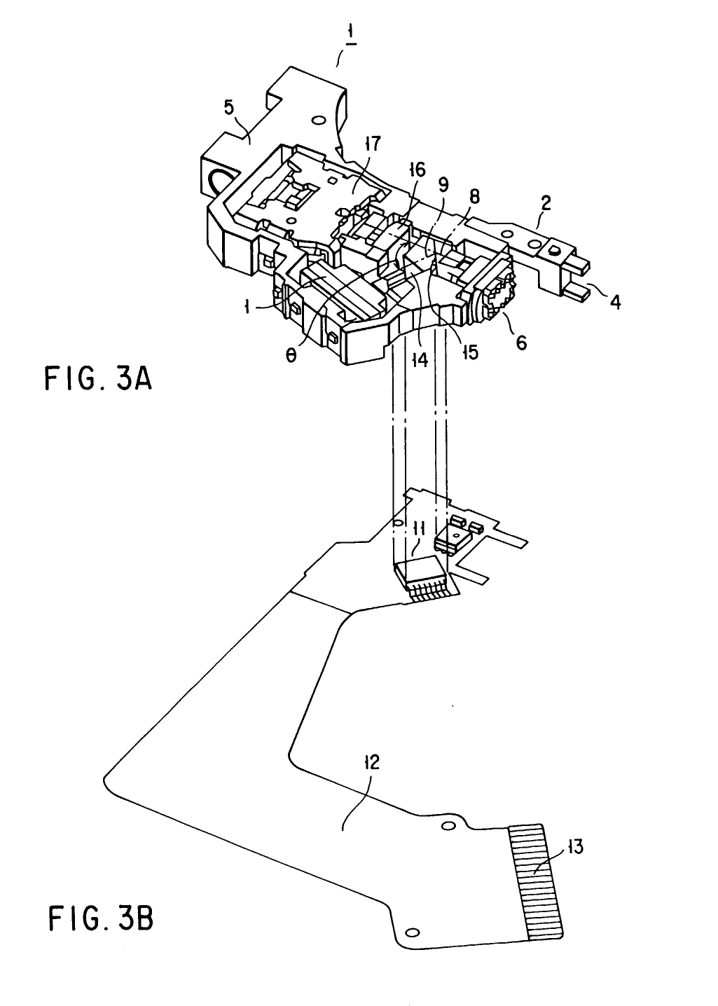

The main beam of the light beam emitted from the CD optical integration unit 6, that is, an optical axis 8 of a system to guide the light beam, and the main beam of the light beam emitted from the DVD optical integration unit 7, that is, an optical axis 9 of a system to guide the light beam intersect at a beam splitter 14, which will be described later with reference to FIG. 3, at an intersection 30. Further, the optical axis 8 and the optical axis 9 are incident with an mutual open angle of θ.

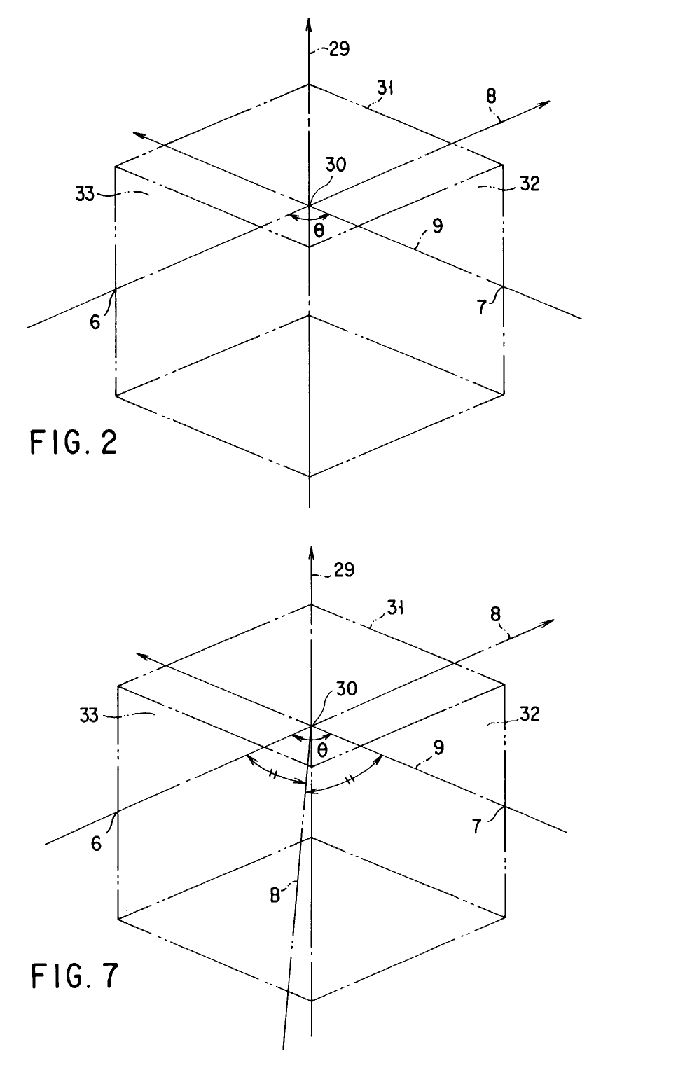

FIG. 2 is a schematic diagram for explaining a space where a driving unit, which supplies predetermined driving currents to the laser elements in the optical pickup shown in FIG. 1, can be disposed.

In FIG. 2, the position of the CD optical integration unit 6 and the position of the DVD optical integration unit 7 are indicated with numerals 6 and 7, respectively.

The aforementioned optical axis 8 (for CD) and the optical axis 9 (for DVD) define a space 31 that is surrounded by a plane 32 and a plane 33. In this case, the plane 32 is defined by a vertical axis 29, which passes the intersection 30 and orthogonal to the both the axis 8 and the axis 9, and orthogonal to the optical axis 9. The plane 33 is defined by a vertical axis 29, which passes the intersection 30 and orthogonal to the both the axis 8 and the axis 9, and orthogonal to the optical axis 8.

In the space 31, it is possible to dispose a laser driver (light source driving unit) 11, which is configured to supply a predetermined driving signal to each of the laser elements built in the CD optical integration unit 6 and the position of the DVD optical integration unit 7.

The laser driver 11 supplies high frequency superposition driving signals to a first laser element for CD (not shown) and a second laser element for DVD (not shown), respectively. The first laser element is built in the CD optical integration unit 6 and emits a light beam having a first wavelength. The second laser element is built in the DVD optical integration unit 7 and emits a light beam having a second wavelength. In the high frequency superposition driving signals, high frequency signals of a predetermined frequency are superposed on driving signals for driving the respective laser elements.

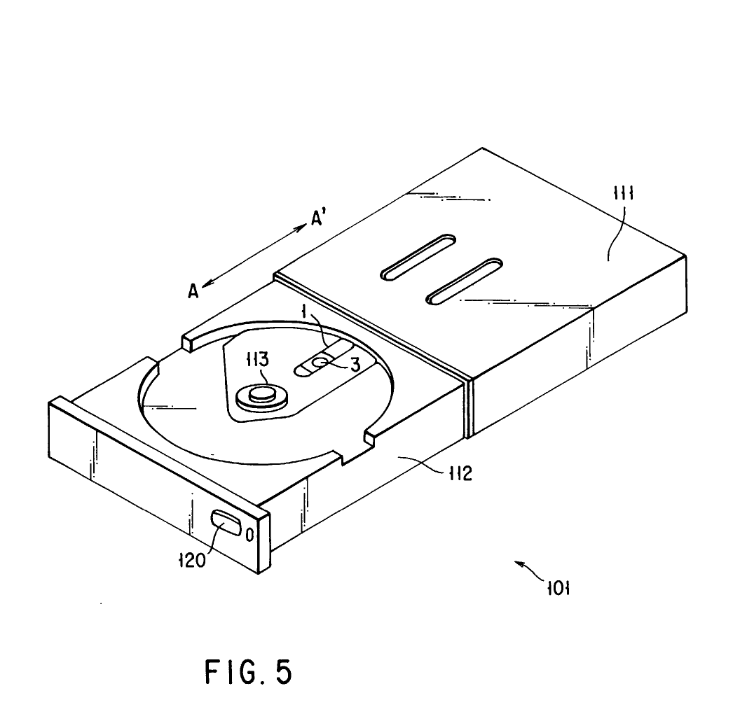

The laser driver 11 is mounted on a flexible printed circuit 12 that is formed with signal lines (not shown) in an integral manner. The laser driver 11 is also connected electrically to the signal lines. In the flexible print circuit 12, a connecter 13 provided at the distal portion thereof is connected electrically to a signal supplying end (not shown) on the side of a body for an optical disk device, will be described later with reference to FIG. 5, so that driving electricity and predetermined signals can be input into the laser driver 11.

The optical pickup 1 is positioned on a guide rod 23 (not shown in FIG. 5 and excerpted in part from the optical disk device is shown in FIG. 1) provided in the optical disk device, which will be described later with reference FIG. 5, such that the optical pickup 1 can move on a guide rod holding unit 4. Then, a guide rod 24 (not shown in FIG. 5 and excerpted in part from the optical disk device is shown in FIG. 1) passes through a guide rod end sliding portion 5, and thus the optical pickup 1 is positioned in the optical disk device in a movable manner in a radius direction of an optical disk (not shown).

Each of the laser elements built in the CD optical integration unit 6 and the DVD optical integration unit 7 irradiates a recording light beam having a wavelength corresponding to an optical disk, to which information can be written in the CD system or the DVD system. Therefore, a recording mark is formed on a signal recording surface of each optical disk, thereby recording signals.

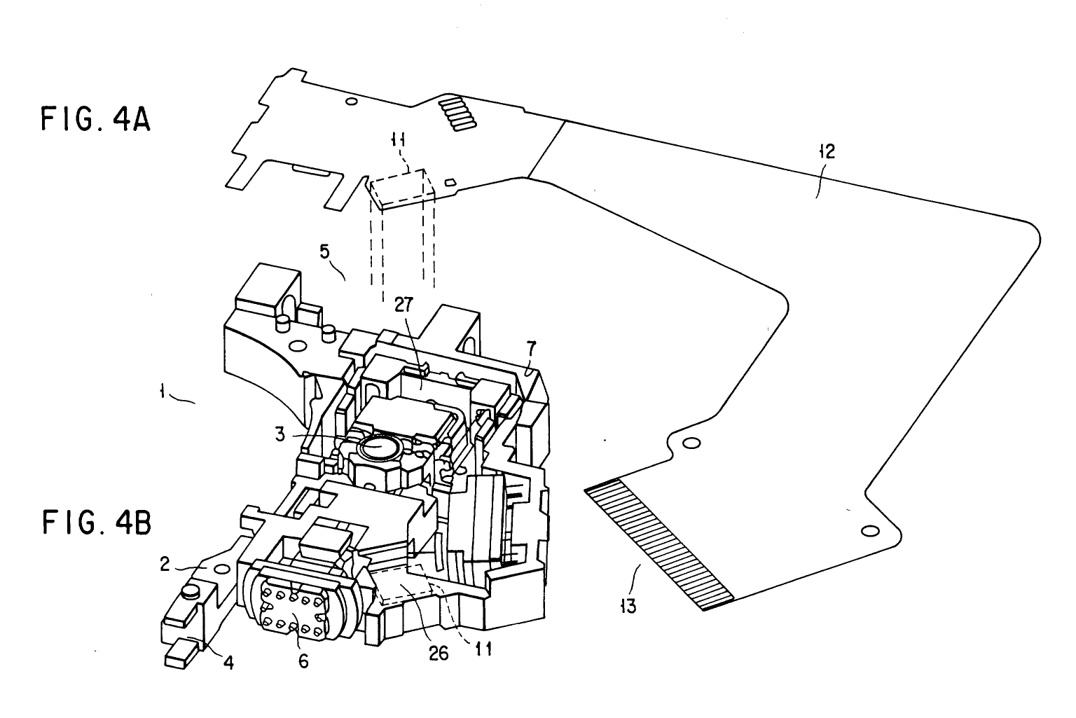

Next, an example of mounting the laser driver 11 on the optical pickup 1 will be described with reference to FIGS. 3A, 3B, 4A and 4B.

FIGS. 3A and 3B are exploded views showing the optical pickup take apart shown in FIG. 1. FIGS. 4A and 4B are exploded views showing the optical pickup shown in FIGS. 3A and 3B viewed from its back (the identical direction to FIG. 1).

As can be seen from FIG. 3A, the beam splitter 14 is positioned at the position where the optical axis 8 (CD system) and the optical axis 9 (DVD system) intersect.

At a predetermined position of the beam splitter 14, a beam split surface 15 is formed. On the beam split surface 15, there is formed a dichroic film, which is provided with reflexivity and permeability corresponding to the wavelength of the light beam provided by each of the laser elements.

On the beam split surface 15 of the beam splitter 14, a light beam emitted from the CD optical integration unit 6 and a light beam emitted from the DVD optical integration unit 7 intersect each other.

The light beam of 780 nm wavelength emitted from the CD optical integration unit 6 passes through the beam split surface 15 of the beam splitter 14. Then, the light beam is guided to a collimating lens 16 and collimated through the lens 16, and then guided to the objective lens 3.

The light beam guided to the objective lens 3 is provided with a predetermined convergence through the objective lens 3, and condensed on the signal recording surface of the optical disk, which is set in the optical disk device shown in FIG. 5. In this case, in the optical disk device, an optical disk of CD system (e.g. CD-R disk) is set.

On the other hand, the light beam of 650 nm wavelength emitted from the DVD optical integration unit 7 is reflected by the beam split surface 15 of the beam splitter 14, and guided to the collimating lens 16. Then, the light beam is collimated and is incident on the objective lens 3.

The light beam incident on the objective lens 3 is provided with a predetermined convergence through the objective lens 3, and condensed on the signal recording surface of the optical disk, which is set in the optical disk device shown in FIG. 5. In this case, in the optical disk device, an optical disk of DVD system (e.g. DVD-RAM disk) is set.

A position where the light beam is condensed on the optical disk of CD system or DVD system is controlled to a predetermined position of the optical disk through a yoke 17 and actuator 27 (see FIGS. 4A and 4B), which collaborates with the yoke 17.

That is, the actuator 27 holding the objective lens 3 is moved to a predetermined position by the magnetic field from the yoke 17, so that the position of the light beam condensed through the objective lens 3 is moved to an arbitrary position on the optical disk.

Incidentally, it can be seen from FIGS. 3A, 3B, 4A and 4B that the laser driver 11 is mounted directly on the flexible print circuit 12.

In addition, the flexible print circuit 12 is fixed on the base 2 of the optical pickup 1.

The laser driver 11 is disposed in the space 31, which is surrounded by the plane 32 and plane 33. In this case, the plane 32 and the plane 33 are defined by the optical axis 8 of the CD optical integration unit 6, the optical axis 9 of the DVD optical integration unit 7, and the vertical axis 29, as described above with use of FIG. 2.

Incidentally, the laser driver 11 is positioned opposing to a space of a notch 26 provided on the base 2 as shown in FIGS. 4A and 4B. Since, the notch 26 has been arranged of at a predetermined position on the base 2. Therefore, the laser driver 11 does not project in a vertical direction of the optical pickup 1.

As described above, the laser drive 11 is disposed in the space 31, which is surrounded by the two planes 32 and 33. In this case, the planes 32 and 33 are defined by a vertical axis 29, which orthogonal to each of the optical axis 8 of the CD optical integration unit 6 and the optical axis 9 of the DVD optical integration unit 7, and orthogonal to the two optical axes 8 and 9. The two axes intersect with the open angle θ. Thus, the distance between the laser element built in the CD optical integration unit 6 and the driver 11, and the distance between the laser element built in the DVD optical integration unit 7 and the driver 11 can be set to the distance between the notch (driver space) 26 on the base 2 and the beam splitter 14 at the maximum.

Accordingly, the length of the signal line connecting the laser driver 11 and the laser element of the CD optical integration unit 6, and the length of signal line connecting the laser driver 11 and the laser element of the DVD optical integration unit 7 can be obtained by the distance between the driver space (notch) 26 on the base 2 and the beam splitter 14, and the distance between the beam splitter 14 and the respective laser elements (CD unit 6 and DVD unit 7).

As a result, solved is the deterioration of driving signals supplied from the laser driver 11 to the laser element of the CD optical integration unit 6, or from the laser driver 11 to the laser element of the DVD optical integration unit 7 (in comparison with the conventional technology).

FIG. 5 is a schematic diagram showing an example of the optical disk device in which the optical pickup shown in FIGS. 1, 2, 3A, 3B, 4A and 4B is built.

As shown in FIG. 5, an optical disk device 101 has a housing 111 and a table unit 112, which can be projected (ejecting, movement in an arrow A direction) or retracted (loading, movement in an arrow A′ direction) from the housing 111.

The table unit 112 has a turntable 113 on which an optical disk (not shown) is mounted.

On the front of the table unit 112, a front panel (no numeral) is provided. On the front panel, there is provided an eject switch 120, which ejects the table unit 112 from the housing 111.

The optical disk is mounted on the turntable 113. Then, the table unit 112 is retracted into in the housing 111, so that the optical disk is set to a predetermined position in the optical disk device.

At a predetermined position in the turntable 113, there is provided the optical pickup 1 according to the invention, which has been described with reference to FIGS. 1, 2, 3A, 3B, 4A and 4B. As it is obvious in FIG. 5, in the state where no optical disk is loaded, the optical pickup 1 can be seen with the objective lens 3 exposed.

The optical pickup 1 provided at a predetermined position in the turntable 113 can move in a radius direction of the optical disk in parallel to the signal recording surface of the optical disk along the guide rod 23 and the guide rod 24 (each shown in FIG. 1).

Then, the light beam emitted from one of the laser elements (not shown) set in the CD optical integration unit 6 and the DVD optical integration unit 7 is condensed at a information recording position (not described in detail) that is set by the movement of the objective lens 3. Thus, the light beam having a recording optical power and a wavelength for corresponding to the type of the optical disks, which is set on the turntable 113 and on which information can be written in the CD system or the DVD system, is irradiated.

As a result, a recording mark is formed on the signal recording surface of each optical disk, thereby recording signals.

Further, in the case where an optical disk on which information has been recorded is set, the light beam having a predetermined wavelength, which is emitted from a laser element for a corresponding optical disk, is condensed at an information reproduction position (not described in detail) that is set by the movement of the objective lens 3. Thus, the light beam having reproducing optical power and a wavelength for corresponding to the type of the disks (CD or DVD) is irradiated. As a result, information from the signal recording surface of each optical disk is reproduced.

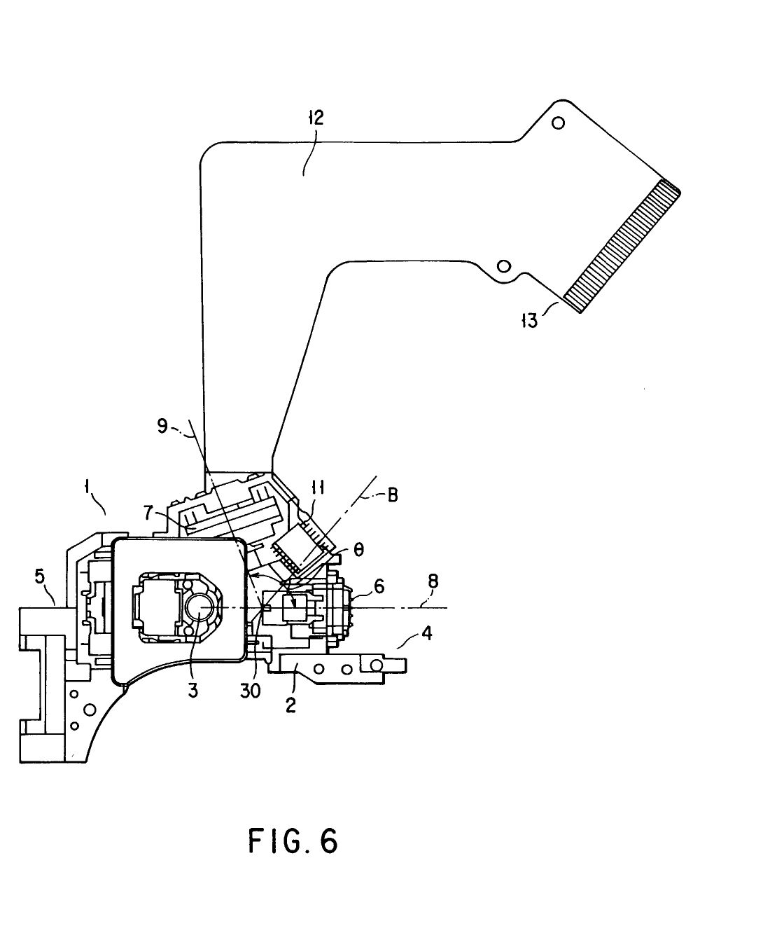

FIG. 6 is a schematic diagram for explaining an example of another embodiment for the optical pickup shown in FIGS. 1, 2, 3A, 3B, 4A and 4B. Incidentally, in FIG. 6, identical structure to FIG. 1 are marked with identical symbols, and a detailed description will be omitted.

FIG. 7 is a schematic diagram for explaining a possible space for disposing a driving unit to supply a predetermined driving current to laser elements in the optical pickup shown in FIG. 6.

In an optical pickup 51 shown in FIG. 6, similarly to the aforementioned description with reference to FIGS. 1, 2, 3A, 3B, 4A and 4B, the optical axis 8 of the CD optical integration unit 6 and the optical axis 9 of the DVD optical integration unit 7 intersect with the open angle of θ.

As shown in FIG. 7, the optical axis 8 (for CD) and the optical axis 9 (for DVD) define a space 31 that is surrounded by a plane 32 and a plane 33. In this case, the plane 32 is defined by a vertical axis 29, which passes the intersection 30 and orthogonal to the both the axis 8 and the axis 9, and orthogonal to the optical axis 9. The plane 33 is defined by a vertical axis 29, which passes the intersection 30 and orthogonal to both the axis 8 and the axis 9, and orthogonal to the optical axis 8. In the space 31, it is possible to dispose a laser driver 11, which is configured to supply a predetermined driving signal to each of the laser elements built in the CD optical integration unit 6 and the DVD optical integration unit 7. More specifically, in the optical pickup 51 shown in FIG. 7, the laser driver 11 is positioned on a bisector B, which divides the open angle θ defined by the plane 32 and the plane 33 in half.

The laser driver 11 is disposed on the bisector B, which divides the open angle θ defined by the plane 32 and the plane 33 in the space 31 in half. In this case, the space 31 is provided by surrounding with plane 32 and the plane 33. The plane 32 and the plane 33 are defined by a vertical axis 29, which orthogonal to the optical axis 8 of the CD optical integration unit 6 and the optical axis 9 of the DVD optical integration unit 7, and orthogonal to the two optical axes 8 and 9. The two optical axes 8 and 9 mutually intersect with open angle of θ. Thus, it is possible to set two distances or the lengths of the signal lines, that is, the distance (the length of the signal line) between the laser element built in the CD optical integration unit 6 and the laser driver 11, and the distance (the length of the signal line) between the laser element built in the DVD optical integration unit 7 and the laser driver 11, to the distance between the notch (driver space) 26 on the base 2 and the beam splitter 14 at the maximum, and set the two distances to be substantially equivalent.

Therefore, the length of the signal line connecting the laser driver 11 to the laser element of the CD optical integration unit 6 and the length of the signal line connecting the laser driver 11 to the laser element of the DVD optical integration unit 7 can be set within the distance between the distance from the driver space 26 on the base 2 to the beam splitter 14 and the distance from the beam splitter 14 and each of the laser element (CD unit 6 and DVD unit 7), and set to be substantially equivalent.

As a result, it becomes possible to solve (in comparison with the conventional technology) the deterioration of driving signals supplied from the laser driver 11 to the laser element of the CD optical integration unit 6 and from the laser driver 11 to the laser element of the DVD optical integration unit 7. Further, even if the signals deteriorate, the degree of their deterioration is substantially equal.

As described above, in the optical pickup according to the invention, a laser driver 22 is positioned opposing a space of the step portion 26 provided on the base 2 in the space 31. Therefore, the laser driver 11 does not project in a vertical direction of the optical pickup 1. In this case, the space 31 is defined by the plane 32 and the plane 33, and the plane 31 is defined by the vertical axis 29 and the optical axis 8 and the plane 33 is defined by the vertical axis 29 and the optical axis 9, the vertical axis 29 passing the intersection 30 where the optical axes 8 and 9 intersect, and being vertical to the two axes 8 and 9.

Further, the laser driver 11 is disposed on the bisector B of the open angle of θ. Therefore, deterioration of the driving signal supplied to either laser elements of the CD system 6 and the DVD system 7 can be reduced to the minimum extent.

Incidentally, in the embodiment described above, the laser driver superposes high frequency signals on the driving signals output to either of a first laser element and a second laser element. However, it is needless to mention that the laser drivers may be provided individually for the first laser element and the second laser element.

In this case, it is obvious that the effect of the invention can be achieved if only the laser drivers are disposed in a space surrounded by two planes, or disposed on a bisector, which divides a mutual open angle between the two planes in half. Incidentally, the relevant space is provided by being surrounding with two planes, which are defined by a vertical axis and the optical axis of the first system, and with the vertical axis and the optical axis of the second system, respectively. The vertical axis is vertical to both of the optical axes of the systems including a first laser element and a second laser element.

As described above, in the optical pickup and the optical disk device according to the invention, there is provided an optical pickup in which driving signals supplied to light sources deteriorates less and an optical disk device using this optical pickup.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical pickup comprising:
a first light source to emit a light beam having a first wavelength;
a second light source to emit a light beam having a second wavelength; and
a light source driving unit to position in a space which is surrounded by a first plane defined by a vertical axis and a first optical axis and a second plane defined by the vertical axis and a second optical axis, the first optical axis defining a direction in which a light beam from the first light source proceeds, the second optical axis defining a direction in which a light beam from the second light source proceeds, the vertical axis being vertical to an intersection where the first optical axis and the second optical axis intersect each other.

2. The optical pickup according to claim 1, wherein the light source driving unit is capable of superposing a first high frequency signal having a predetermined frequency on a driving signal to drive the first light source, and is capable of superposing a second high frequency signal having a predetermined frequency on a driving signal to drive the second light source.

3. An optical pickup according to claim 1,
wherein the light source driving unit is positioned in a space surrounded by the first plane and the second plane, and at the position where the angle formed by the first plane and the second plane is divided in half.

4. The optical pickup according to claim 3, wherein the light source driving unit is capable of superposing a first high frequency signal having a predetermined frequency on a driving signal to drive the first light source, and is capable of superposing a second high frequency signal having a predetermined frequency on a driving signal to drive the second light source.

5. An optical disk device comprising:
a first light source to emit a light beam having a first wavelength;
a second light source to emit a light beam having a second wavelength;
a light source driving unit to position in a space which is surrounded by a first plane defined by a vertical axis and a first optical axis and a second plane defined by the vertical axis and a second optical axis, the first optical axis defining a direction in which a light beam from the first light source proceeds, the second optical axis defining a direction in which a light beam from the second light source proceeds, the vertical axis being vertical to an intersection where the first optical axis and the second optical axis intersect each other;
a turntable on which an optical disk is mounted; and
a guide member to guide the optical pickup in a radius direction of the optical disk mounted on the turntable.

6. The optical disk device according to claim 5, wherein the light source driving unit is capable of superposing a first high frequency signal having a predetermined frequency on a driving signal to drive the first light source, and is capable of superposing a second high frequency signal having a predetermined frequency on a driving signal to drive the second light source.

7. The optical disk device according to claim 5, wherein the light source driving unit is positioned in a space surrounded by the first plane and the second plane, and at the position where the angle formed by the first plane and the second plane is divided in half.

8. The optical disk device according to claim 6, wherein the light source driving unit is positioned in a space surrounded by the first plane and the second plane, and at the position where the angle formed by the first plane and the second plane is divided in half.
